(19) United States
(12) Patent Application Publication
(10) Pub. No.: US 2026/0222278 A1
(43) Pub. Date: Jul. 30, 2026

(54) APPROACHES FOR DISASTER DETECTION AND RECOVERY OF CLOUD INFRASTRUCTURE AND SERVICES

(71) Applicant: Salesforce, Inc., San Francisco, CA (US)

(72) Inventor: Jyothi Balaka, San Francisco, CA (US)

(21) Appl. No.: 19/041,237

(22) Filed: Jan. 30, 2025

(51) Int. Cl. H04L 41/0663; H04L 41/0604; H04L 41/16

(52) U.S. Cl. CPC H04L 41/0663; H04L 41/0618; H04L 41/16

(57) ABSTRACT

Methods and corresponding systems and apparatuses for disaster detection and recovery of cloud infrastructure are described. Internal telemetry data corresponding to a plurality of levels of a cloud infrastructure may be obtained. At least one outage to at least one of the plurality of levels of the cloud infrastructure may be predicted. A threshold likelihood of at least one outage to the cloud infrastructure may be determined based at least in part on the at least one predicted outage. In response to determining the threshold likelihood of the at least one outage, an automated disaster recovery process to failover the at least one of the plurality of levels of the cloud infrastructure may be initiated .

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to disaster detection and recovery systems for cloud-based services and infrastructure.

### BACKGROUND

Cloud computing environments are prone to various types of disruptions, ranging from issues affecting a single tenant or service to large-scale outages impacting entire availability zones or regions. For example, cloud outages may occur for many reasons, such as power failures, configuration mistakes, cybersecurity breaches, technical problems, software bugs, networking issues, and environmental causes. These outages can range from brief disruptions to prolonged service unavailability, affecting businesses and users worldwide.

### BRIEF DESCRIPTION OF THE DRAWINGS

The included drawings are for illustrative purposes and serve only to provide examples of possible structures and process steps for the disclosed techniques. These drawings in no way limit any changes in form and detail that may be made to implementations by one skilled in the art without departing from the spirit and scope of the disclosure.

FIG. 1 shows a block diagram of an example computing environment, according to some embodiments.

FIG. 2 illustrates an example diagram of hierarchy levels of cloud infrastructure, according to some embodiments.

FIG. 3 illustrates an example diagram of internal telemetry data corresponding to a hierarchy of levels in cloud infrastructure, according to some embodiments.

FIG. 4 illustrates an example diagram of external telemetry data, according to some embodiments.

FIG. 5 illustrates an example flow diagram, according to some embodiments.

FIG. 6 illustrates another example flow diagram, according to some embodiments.

FIG. 7 shows a flow diagram of an example process, according to some embodiments.

FIG. 8A shows a system diagram illustrating architectural components of an applicable environment, in accordance with some implementations.

FIG. 8B shows a system diagram further illustrating architectural components of an applicable environment, in accordance with some implementations.

FIG. 9 shows a system diagram illustrating the architecture of a multi-tenant database environment, in accordance with some implementations.

FIG. 10 shows a system diagram further illustrating the architecture of a multi-tenant database environment, in accordance with some implementations.

### DETAILED DESCRIPTION

Examples of systems and methods are described herein with reference to certain implementations. These examples are being provided solely to add context and aid in the understanding of the present disclosure. It will thus be apparent to one skilled in the art that the techniques described herein may be practiced without some or all of these specific details. In other instances, well-known process operations have not been described in detail in order to avoid unnecessarily obscuring the present disclosure. Other applications are possible, such that the following examples should not be taken as definitive or limiting either in scope or setting.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer-readable medium such as a non-transitory computer-readable storage medium containing computer-readable instructions or computer program code, or as a computer program product comprising a computer usable medium having a computer-readable program code embodied therein.

Cloud computing environments are prone to disruptions, ranging from issues affecting a single tenant or service to large-scale outages impacting entire availability zones or regions. Traditional disaster recovery (DR) solutions often focus solely on region-level outages, making them inefficient for addressing more granular disruptions that can severely impact specific users or services. Further, existing solutions may rely on fixed thresholds or manual interventions, which may result in delayed responses and service interruptions. Additionally, existing solutions may lack mechanisms to combine internal telemetry data with real-time external event detection, leading to either false positives or missed critical events.

Embodiments described herein provide a claimed solution that is necessarily rooted in computer technology (e.g., computer networks). The claimed solution addresses these challenges using a disaster recovery (DR) system for cloud environments. The DR system is capable of detecting and responding to outages (or disruptions) at different levels of granularity, including outages at a tenant level, a service level, an availability zone (AZ) level, and a region level.

According to some embodiments, the DR system includes a telemetry monitoring application that continuously tracks telemetry data, which may be obtained from cloud services, databases, and applications. For example, the telemetry data may include various cloud infrastructure metrics, network latency, replication lag, API error rates, CPU and memory utilization, among others. The telemetry monitoring application may apply synthetic monitoring techniques to simulate transactions across services to proactively detect availability issues affecting tenants or specific services. Further, the telemetry monitoring application may employ AI anomaly detection models to evaluate deviations in metrics at the tenant level, cell level, availability zone (AZ) level, and region level. Such deviations may include increases in API latency or replication lag affecting specific tenants or services. The AI anomaly detection models may implement machine learning models, such as auto-encoders and clustering algorithms, to analyze telemetry data and predict outages (or disruptions) at the different levels. The models may integrate historical outage data with real-time metrics to improve prediction accuracy. The models may be applied to generate scores indicating a likelihood of disruption at the tenant, cell, AZ, or region level.

According to some embodiments, in addition to evaluating telemetry data, the DR system may employ an external event detection application to obtain real-time data from various external sources, including news feeds, weather APIs, and social media platforms. The real-time data may be queried using prompt engineering to extract information about relevant events (e.g., natural disasters, service outages, infrastructure failures, etc.) that may impact the different levels of the cloud environment, such as specific regions or availability zones. The external event detection application may assign confidence scores based on the credibility of the source, event severity, and geographical proximity.

According to some embodiments, based on analysis of the telemetry data and real-time data, the DR system may determine a decision score, which is used to determine whether to initiate a disaster recovery (DR) process. When the decision score satisfies a threshold, the DR system determines that a significant event has occurred and triggers an appropriate DR response. As an example, the DR system may execute failover scripts to redirect traffic to a pre-synchronized DR region or alternate service instance. The DR system may use configuration management tools to update infrastructure configurations. Further, the DR system may validate the readiness of the DR region or service instance before completing the transition.

The claimed solution provides a number of advantages over conventional approaches, such as reduced false positives, accelerated decision-making, and enhanced reliability of disaster recovery in cloud environments. Further details and advantages are provided herein throughout the disclosure.

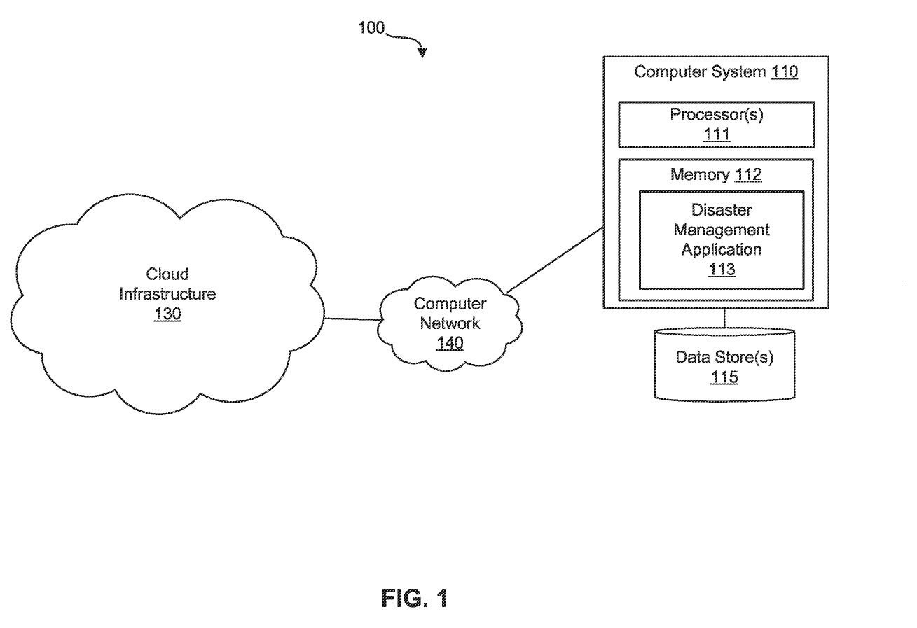

FIG. 1 shows a block diagram of an example computing environment 100 incorporating one or more implementations. The computing environment 100 includes a computer system 110 and cloud infrastructure 130, which may communicate through one or more computer networks 140 (e.g., the Internet). The computer network(s) 140 may include one or more wireless networks, one or more wired networks, or a combination of wired and wireless networks. For example, the computer network 140 may be any one or any combination of one or more LANs (local area networks), WANs (wide area networks), telephone networks, and wireless networks, among others.

The computer system 110 may include one or more processors 111 and memory 112. The processor(s) 111 may include general-purpose processors, special-purpose processors, or combinations thereof. The memory 112 may include one or more memory devices comprising non-volatile storage, volatile storage, or a combination thereof. The computer system 110 may be configured to provide access to a disaster management application 113, for example, upon execution by the processor(s) 111. In various embodiments, the computer system 110 may implement a Software as a Service (SaaS) model, a Platform as a Service (PaaS) model, or any other cloud computing model to facilitate access to the disaster management application 113. The computer system 110 may be associated with one or more data stores 115, which may be accessible through wired or network-based connections. The disaster management application 113 may be configured to detect and respond to various scenarios that disrupt access to various hierarchical components (or levels, or layers) of the cloud infrastructure 130, as described herein.

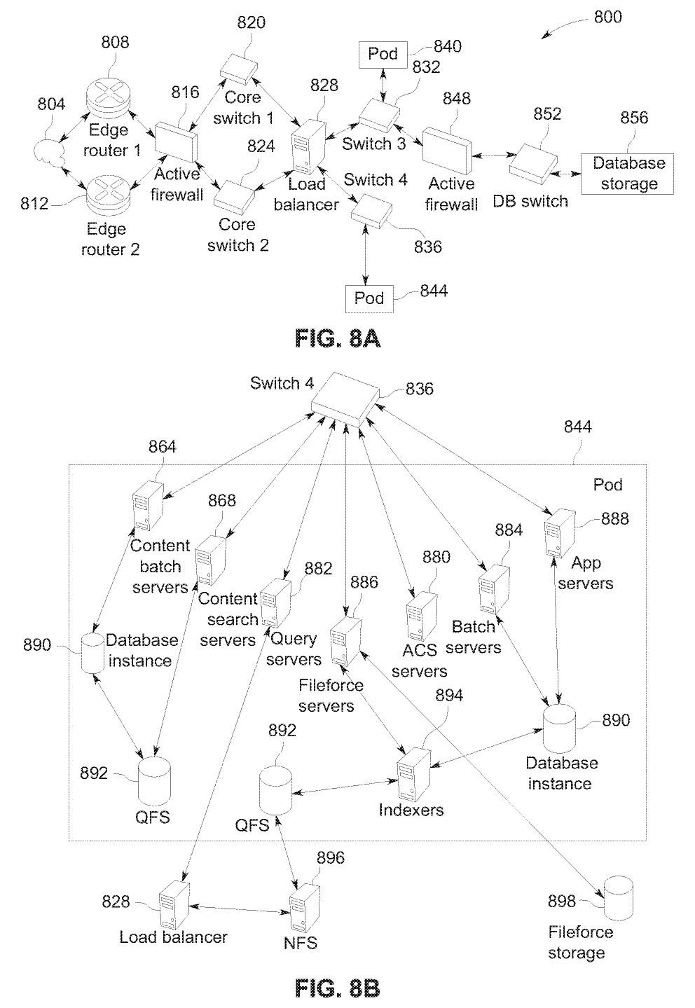

The cloud infrastructure 130 may include hierarchical levels that operate together to provide various cloud-based services and infrastructure, and which may include various aspects of the architecture and environments described in reference to FIGS. 8A-8B, 9, and 10.

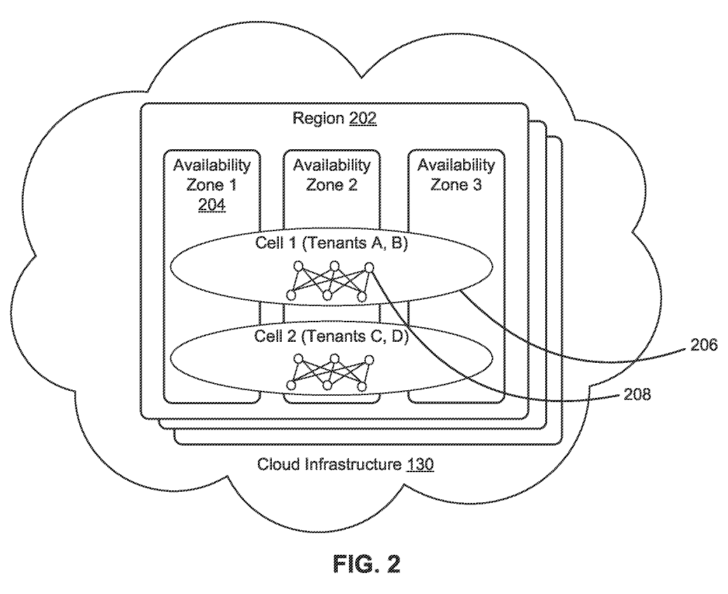

As an example, FIG. 2 illustrates an example diagram of hierarchy levels of cloud infrastructure, including a region level 202, an availability zone (AZ) level 204, a cell level 206, and a tenant level 208. The region level 202 may represent a geographically distinct region (or area). In general, cloud resources allocated by region may operate independently from each other and are typically separated by significant distances. A region may include multiple availability zones. The availability zone level 204 may correspond to one or multiple availability zones (e.g., Availability Zone 1, Availability Zone 2, Availability Zone 3) within the region. An availability zone may be a physically and logically separated data center within the region having independent power, networking, and cooling systems. These availability zones may be connected through redundant, low-latency, and high-bandwidth networks, providing fault isolation while maintaining high availability. The cell level 206 may represent one or more cells that span one or more availability zones. A cell (e.g., Cell 1, Cell 2) may be a logical construct that manages a specific group of tenants and their associated services. The cell may operate as an isolated deployment that can handle requests independently and typically spans multiple availability zones (e.g., Availability Zone 1, Availability Zone 2, Availability Zone 3) for redundancy. The cell thus helps contain potential issues, ensuring that problems affecting one cell do not impact customers in other cells. Each cell may host a number of tenants at a tenant level. For example, a first cell (e.g., Cell 1) may host tenants A and B, while a second cell (e.g., Cell 2) may host tenants D and E. The tenant level 208 may represent one or more tenants that are hosted by a given cell. Each tenant may be allocated a separate namespace, resource quotas, access controls, custom domain name system (DNS) records for tenant-specific domains, dedicated security boundaries to ensure data isolation, and load balancers to manage tenant access and distribute workloads. The tenant level 208 may help ensure that multiple tenants (or customers) can securely share software and hardware resources while maintaining strict isolation and corresponding access privileges.

According to various embodiments, internal telemetry data may be provided to (or obtained by) the disaster management application 113 of computer system 110 from the various hierarchical levels of the cloud infrastructure 130. For example, such telemetry data may include real-time metrics (e.g., performance indicators, resource utilization, API error rates, etc.), logs (e.g., error messages, system events, etc.), traces (e.g., request paths through distributed systems), and events (e.g., user interactions, system state changes, etc.), among others. The telemetry data may be analyzed, for example, to determine system health and performance. For example, at the region level 202, telemetry data may include data on overall resource utilization, network traffic patterns, and service availability across multiple availability zones. This data can help identify region-wide trends and issues. At the availability zone level 204, the telemetry data may provide more granular metrics, such as power consumption, cooling system performance, and network equipment status within specific data centers. At the cell level 206, the telemetry data may provide detailed information about individual infrastructure stacks, including application service instances, database performance, and resource allocation within isolated fault boundaries. At the tenant level 208, the telemetry data may provide user-specific metrics, such as application performance, resource usage, and security-related events for individual customer (or tenant) environments. In general, such telemetry data may be provided (or obtained) using one or more application programming interfaces (APIs) or frameworks.

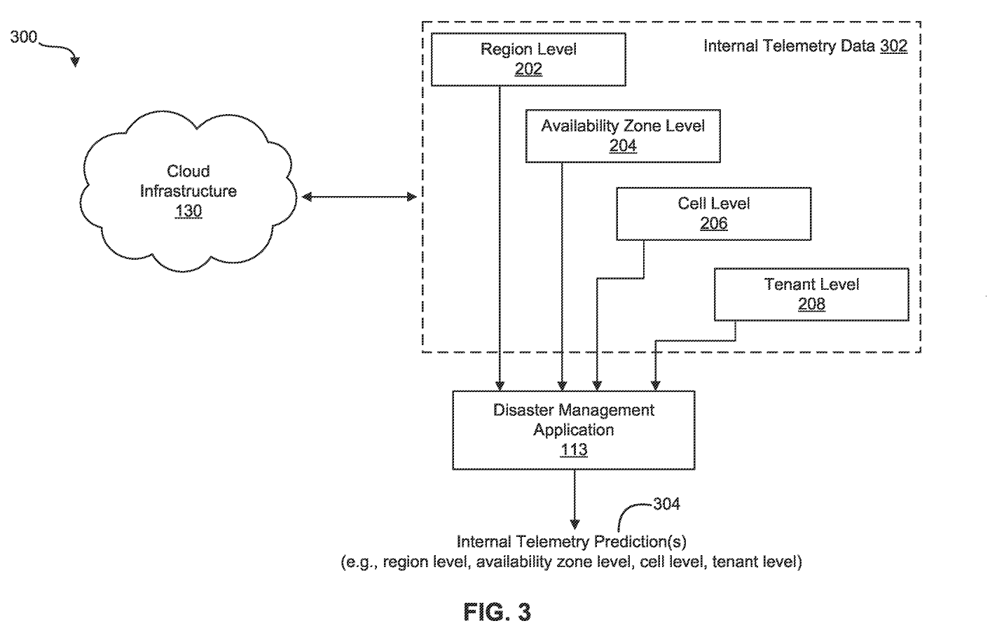

According to some embodiments, the disaster management application 113 may be configured to continuously monitor (or poll) such internal telemetry data, for example, from the hierarchical levels of the cloud infrastructure 130. For example, FIG. 3 illustrates an example diagram of internal telemetry data 302 corresponding to a hierarchy of cloud infrastructure levels. In this example, the hierarchy includes the region level 202, the availability zone level 204, the cell level 206, and the tenant level 208 of the cloud infrastructure 130. According to some embodiments, synthetic monitoring techniques may be applied to simulate transactions across services to proactively detect availability issues (or outages) affecting tenants or specific services. For example, the disaster management application 113 may be configured to implement synthetic monitoring techniques to simulate user interactions and transactions across various levels of the cloud infrastructure 130, thereby facilitating proactive detection of performance issues and ensuring service availability.

According to various embodiments, the internal telemetry data 302 may be evaluated to predict outages (or availability issues) 304 for various hierarchical levels of the cloud infrastructure 130. For example, in some embodiments, the disaster management application 113 may be configured to ingest and evaluate the internal telemetry data 302 to predict the likelihood of an outage at the region level 202, the availability zone level 204, the cell level 206, and/or the tenant level 208. According to some embodiments, the disaster management application 113 may be configured to implement an artificial intelligence (AI) anomaly detection model to predict the outage likelihoods. According to some embodiments, the AI anomaly detection model may be trained to evaluate the internal telemetry data 302 to predict outages across the different hierarchical levels (e.g., the regional level 202, the availability zone level 204, the cell level 206, and the tenant level 208). The AI anomaly detection model may analyze the vast amounts of internal telemetry data 302 generated by the cloud infrastructure 130, including metrics from the region level 202, availability zone level 204, cell level 206, and individual tenants 208. For example, at the region level 202, the AI anomaly detection model may be trained on aggregated data from multiple availability zones to be able to identify broader trends that might signal region-wide problems. In another example, at the availability zone level 204, the AI anomaly detection model may be trained on more granular metrics, such as power consumption, network equipment status, etc. As another example, at the cell level 206, the AI anomaly detection model may be trained to analyze the internal telemetry data 302 from individual infrastructure stacks, including application service instances and database performance, to detect anomalies within isolated fault boundaries. In yet another example, at the tenant level 208, the AI anomaly detection model may be trained on user-specific metrics to identify issues that may affect individual customer environments. By processing this multi-dimensional data, the AI anomaly detection model can learn to identify patterns and anomalies that may indicate impending failures or performance issues across the different hierarchical levels of the cloud infrastructure 130.

According to some embodiments, the disaster management application 113 may train and apply one or more machine learning models to determine the outage likelihoods based on the internal telemetry data 302. In some implementations, the machine learning models may be auto-encoder architectures that correspond to different layers of cloud infrastructure. For example, for the region level 202, a higher-level auto-encoder may be trained to compress region-wide data. In this example, the higher-level auto-encoder may generate a regional outage likelihood based on deviations from normal (or baseline) regional patterns. In another example, for the availability zone level 204, separate auto-encoders may be implemented for each availability zone to capture zone-specific telemetry patterns. In this example, an auto-encoder may output an availability zone-specific outage likelihood, for example, based on a comparison of current telemetry data against learned normal (or baseline) behavior for the availability zone. In yet another example, for the cell level 206, cell-specific auto-encoders may be implemented for resources (e.g., application service instances, databases, resource utilization, etc.) within a given cell. In this example, the cell-specific auto-encoder may output an outage likelihood for the given cell based on detecting anomalies in telemetry data corresponding to the cell level 206. In another example, for the tenant level 208, tenant-specific auto-encoders may be implemented to capture normal (or baseline) telemetry states for each tenant environment. In this example, a tenant-specific auto-encoder may generate an outage likelihood for the tenant based on detecting anomalies from normal (or baseline) patterns for each tenant. Many variations are possible.

According to various embodiments, the auto-encoder architecture may include an encoder, decoder, and clustering layer. The encoder may be trained to compress input telemetry data into a lower-dimensional latent space. The decoder may be trained to reconstruct the input telemetry data from the latent representation. In some embodiments, reconstructions with high error rates may be identified as potential anomalies. The clustering layer may group similar patterns of telemetry data in latent space. According to some embodiments, the auto-encoder architecture may be trained to reconstruct telemetry data and learn compact representations of the telemetry data. According to some embodiments, clustering algorithms (e.g., K-means clustering) may be applied to the learned latent representations to identify normal (or baseline) operational states and anomaly patterns. According to some embodiments, the AI anomaly detection model may be trained based on an integration of historical outage data with real-time internal telemetry data. In such embodiments, the AI anomaly detection model may be trained to learn correlations between past outages and current conditions. According to various embodiments, the AI anomaly detection model may periodically be refined based on an adaptive learning process. For instance, the disaster management application 113 may be configured to regularly update the AI anomaly detection model with new telemetry and outage data. According to some embodiments, the disaster management application 113 may incorporate feedback from confirmed outages to improve prediction accuracy.

According to various embodiments, external telemetry data may also be considered when determining whether a level of the cloud infrastructure is experiencing an outage. The external telemetry data may include various real-time sources of information (or content), such as news feeds, disaster alerts, social media, and the like. In various embodiments, such external telemetry data may be obtained using one or more application programming interfaces (APIs). In some instances, the external telemetry data may be queried using prompt engineering techniques that are formulated to extract information about relevant events (e.g., natural disasters, service outages, infrastructure failures, etc.) that may impact specific levels of the cloud environment, such as specific regions, availability zones, cells, and tenants.

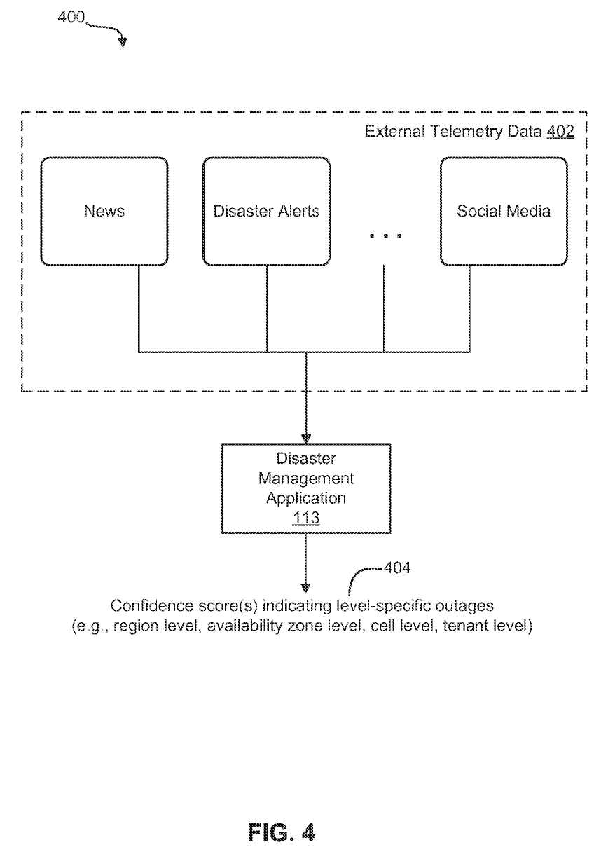

For example, FIG. 4 illustrates an example diagram of external telemetry data 402. The external telemetry data 402 may be obtained and processed by the disaster management application 113 to determine confidence scores 404 that each measure the likelihood of an outage at some level of the cloud infrastructure. For example, the disaster management application 113 may analyze external telemetry data to identify potential threats and anomalies that may lead to outages. For example, at the regional level 202, news reports and disaster alerts about severe weather events, power grid issues, or large-scale cyber attacks may be processed to assess the risk of widespread disruptions. In another example, social media activity, such as an uptick in user reports (or posts) about service problems in a specific area, may indicate early warnings of emerging issues that may affect the availability zone level 204. In yet another example, at the cell level 206, monitoring social media conversations and technical forums may reveal localized problems that may affect individual infrastructure stacks. In another example, at the tenant level 208, insights can be determined by analyzing customer support channels and social media mentions related to specific services or applications managed by the tenant.

According to various embodiments, the confidence scores may be generated from one or more machine learning models trained to recognize patterns and correlations between the external telemetry data and historical outage data for cloud infrastructure. In some implementations, a machine learning model may be trained to generate a respective confidence score for each level of the cloud infrastructure based on features, such as the credibility of the source from which the external telemetry data was obtained, the severity of an event determined based on the external telemetry data, a geographic proximity of the event to the level of the cloud infrastructure, or a combination thereof. According to some embodiments, training data for training such machine learning models may include feature representations of external telemetry data and signals to indicate which levels of the cloud infrastructure are impacted by outages reflected by the external telemetry data. In some implementations, the disaster management application 113 may apply natural language processing techniques to extract relevant information from unstructured text data. In another example, the disaster management application 113 may apply sentiment analysis to help gauge the severity of reported issues. Many variations are possible.

According to some embodiments, the disaster management application 113 may determine whether to initiate an automated disaster recovery process. The automated disaster recovery process may be initiated to transition (or failover) one or more levels of the cloud infrastructure to alternate levels of the cloud infrastructure. For example, at the tenant level 208, individual workloads may be migrated between cells or availability zones without impacting other tenants, ensuring service continuity while maintaining proper isolation. In other examples, cells may failover to other cells, availability zones may failover to other availability zones, and, similarly, regions to other regions.

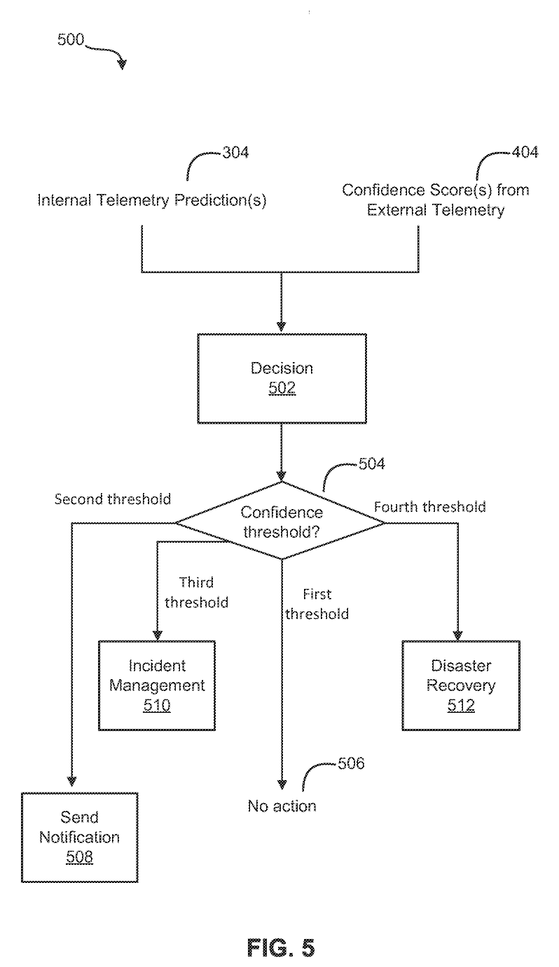

In various embodiments, when determining whether to trigger the automated disaster recovery process, the disaster management application 113 may determine decision scores based on evaluations of internal and external telemetry data. For example, FIG. 5 illustrates an example flow diagram 500 for determining whether to trigger the automated disaster recovery process. In the example of FIG. 5, at block 502, outage likelihoods determined based on the internal telemetry data 302 and confidence scores determined based on the external telemetry data 402 may be evaluated together to determine a decision score. In some embodiments, the decision score may be determined as a weighted sum of the outage likelihoods 304 and the confidence scores 404. The weights may be tuned. For example, the weights may be tuned to give greater weight to internal telemetry data over external telemetry data. Many variations are possible.

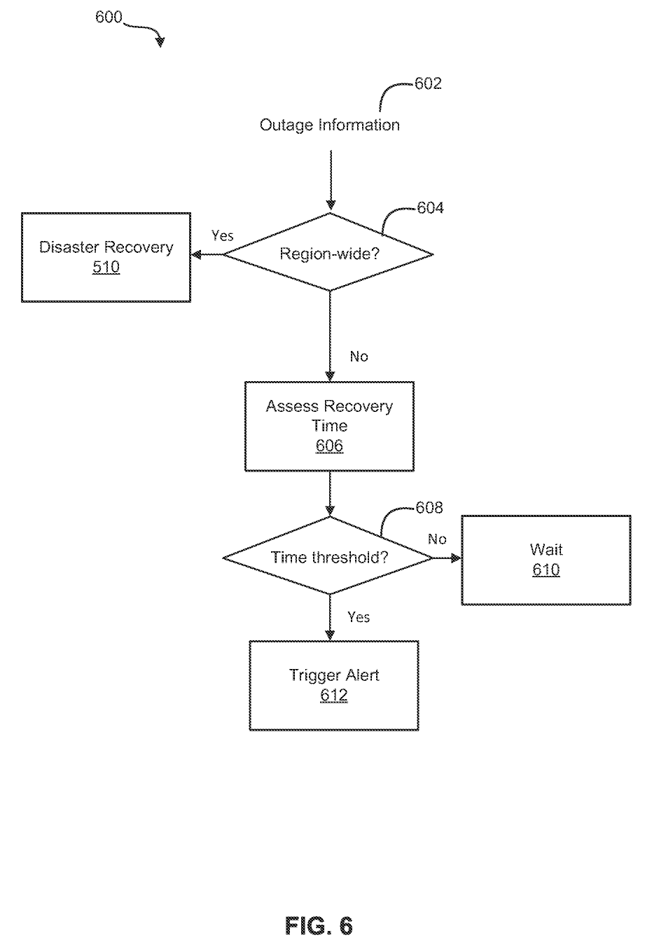

The decision score indicates whether some action should be initiated, such as the automated disaster recovery process. At block 504, the disaster management application 113 may evaluate the decision score to determine an appropriate action. According to some embodiments, if the decision score satisfies a first threshold value (or range) (e.g., less than 10 percent), the disaster management application 113 may determine that no action 506 needs to be taken. In some embodiments, if the decision score satisfies a second threshold value (or range) (e.g., between 10 and 90 percent), the disaster management application 113 may determine there is a low confidence of an outage and accordingly provide a notification to an incident management system 508 with a low confidence note, suggesting that immediate action by an incident management system is not required. In some embodiments, if the decision score satisfies a third threshold value (or range) (e.g., between 90 and 99 percent), the disaster management application 113 may initiate an incident management process 510, as described further in reference to FIG. 6. In some embodiments, if the decision score satisfies a fourth threshold value (or range) (e.g., greater than 99 percent), the disaster management application 113 may initiate the automated disaster recovery process 512 that causes one or more impacted levels of the cloud infrastructure to transition (or failover) to different levels of the cloud infrastructure.

FIG. 6 illustrates an example flow diagram 600 for the incident management process 510, according to some embodiments. For example, outage information 602 determined based on processing the internal and external telemetry data, as described above, may be evaluated at block 604. At block 604, a determination may be made whether a region-wide outage is predicted. In some embodiments, if a region-wide outage is predicted, the outage information may be reviewed based on an incident management protocol and approval hierarchy, and if approved, the automated disaster recovery process 512 may be initiated. In some embodiments, if the outage is not expected to be region-wide, at block 606, an amount of time for the cloud infrastructure to recover from the outage may be determined. For example, the amount of time may be partly determined based on vendor feedback. At block 608, a determination is made whether the amount of time to recover from the outage satisfies a threshold value (or range). For example, if the amount of time to recover is less than 12 hours, a determination may be made to wait 610 for the cloud infrastructure to recover. In another example, if the amount of time to recover is greater than 12 hours, a determination may be made to trigger one or more alerts 612 to various cloud infrastructure operations teams to escalate disaster recovery. Many variations are possible.

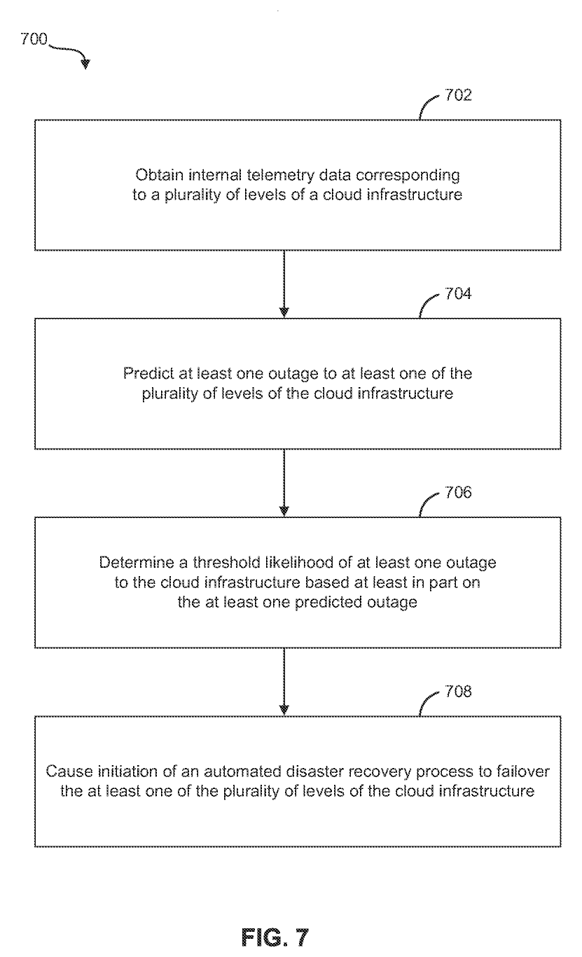

FIG. 7 shows a flow diagram of an example process 700, according to some embodiments. The process 700 can be performed by one or more processors of a computer system, such as the computer system 110 of FIG. 1.

At block 702, the computer system may obtain internal telemetry data corresponding to a plurality of levels of a cloud infrastructure. According to some embodiments, the plurality of levels of the cloud infrastructure include at least a region level, an availability zone level, a cell level, and a tenant level. In some embodiments, the automated disaster recovery process causes the at least one of the plurality of levels of the cloud infrastructure to failover to a different region, availability zone, or cell.

At block 704, the computer system may predict at least one outage to at least one of the plurality of levels of the cloud infrastructure. According to some embodiments, the at least one outage to the at least one of the plurality of levels of the cloud infrastructure is predicted by an artificial intelligence (AI) anomaly detection model that evaluates the internal telemetry data based at least in part on historical outage data corresponding to the cloud infrastructure. In some embodiments, the AI anomaly detection model is trained to output respective likelihoods of outages at a region level, an availability zone level, a cell level, and a tenant level of the cloud infrastructure based at least in part upon the evaluation. In some embodiments, the AI anomaly detection model corresponds to an auto-encoder architecture that includes an encoder trained to compress telemetry data in latent space, a decoder to reconstruct telemetry data, and a clustering layer to group similar patterns of telemetry data.

At block 706, the computer system may determine a threshold likelihood of at least one outage to the cloud infrastructure based at least in part on the at least one predicted outage. According to some embodiments, respective confidence scores for one or more real-world incidents that affect one or more of the plurality of levels of the cloud infrastructure may be determined based at least in part on external telemetry data. In such embodiments, the threshold likelihood of the at least one outage to the cloud infrastructure is determined based at least in part on the at least one predicted outage and the respective confidence scores. In some embodiments, the external telemetry data includes at least one of a news feed data, weather data, disaster alert data, or social media data. In some embodiments, a confidence score for a real-world incident is based on a credibility of the external telemetry data reporting the real-world incident, a severity associated with the real-world incident, and a geographical proximity between the real-world incident and the cloud infrastructure.

At block 708, in response to determining the threshold likelihood of the at least one outage, the computer system may cause initiation of an automated disaster recovery process to failover the at least one of the plurality of levels of the cloud infrastructure. According to some embodiments, upon completing the automated disaster recovery process, network traffic to the at least one of the plurality of levels of the cloud infrastructure is redirected to another region, availability zone, or cell.

FIG. 8A shows a system diagram illustrating architectural components of an on-demand service environment 800, in accordance with some implementations. For instance, the on-demand service environment 800 may correspond to an implementation of computing environment 100 in FIG. 1. A client machine located in the cloud 804 (or Internet) may communicate with the on-demand service environment via one or more edge routers 808 and 812. The edge routers may communicate with one or more core switches 820 and 824 via firewall 816. The core switches may communicate with a load balancer 828, which may distribute server load over different pods, such as pods 840 and 844. The pods 840 and 844, which may each include one or more servers and/or other computing resources, may perform data processing and other operations used to provide on-demand services. Communication with the pods may be conducted via pod switches 832 and 836. Components of the on-demand service environment may communicate with a database storage system 856 via a database firewall 848 and a database switch 852.

As shown in FIGS. 8A and 8B, accessing an on-demand service environment may involve communications transmitted among a variety of different hardware and/or software components. Further, the on-demand service environment 800 is a simplified representation of an actual on-demand service environment. For example, while only one or two devices of each type are shown in FIGS. 8A and 8B, some implementations of an on-demand service environment may include anywhere from one to many devices of each type. Also, the on-demand service environment need not include each device shown in FIGS. 8A and 8B or may include additional devices not shown in FIGS. 8A and 8B.

Moreover, one or more of the devices in the on-demand service environment 800 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 804 is intended to refer to a data network or plurality of data networks, often including the Internet. Client machines located in the cloud 804 may communicate with the on-demand service environment to access services provided by the on-demand service environment. For example, client machines may access the on-demand service environment to retrieve, store, edit, and/or process information.

In some implementations, the edge routers 808 and 812 route packets between the cloud 804 and other components of the on-demand service environment 800. The edge routers 808 and 812 may employ the Border Gateway Protocol (BGP). The BGP is the core routing protocol of the Internet. The edge routers 808 and 812 may maintain a table of IP networks or ‘prefixes’ which designate network reachability among autonomous systems on the Internet.

In one or more implementations, the firewall 816 may protect the inner components of the on-demand service environment 800 from Internet traffic. The firewall 816 may block, permit, or deny access to the inner components of the on-demand service environment 800 based upon a set of rules and other criteria. The firewall 816 may act as one or more of a packet filter, an application gateway, a stateful filter, a proxy server, or any other type of firewall.

In some implementations, the core switches 820 and 824 are high-capacity switches that transfer packets within the on-demand service environment 800. The core switches 820 and 824 may be configured as network bridges that quickly route data between different components within the on-demand service environment. In some implementations, the use of two or more core switches 820 and 824 may provide redundancy and/or reduced latency.

In some implementations, the pods 840 and 844 may perform the core data processing and service functions provided by the on-demand service environment. Each pod may include various types of hardware and/or software computing resources. An example of the pod architecture is discussed in greater detail with reference to FIG. 8B.

In some implementations, communication between the pods 840 and 844 may be conducted via the pod switches 832 and 836. The pod switches 832 and 836 may facilitate communication between the pods 840 and 844 and client machines located in the cloud 804, for example via core switches 820 and 824. Also, the pod switches 832 and 836 may facilitate communication between the pods 840 and 844 and the database storage 856.

In some implementations, the load balancer 828 may distribute workload between the pods 840 and 844. Balancing the on-demand service requests between the pods may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848. The database firewall 848 may act as a computer application firewall operating at the database application layer of a protocol stack. The database firewall 848 may protect the database storage 856 from application attacks such as structure query language (SQL) injection, database rootkits, and unauthorized information disclosure.

In some implementations, the database firewall 848 may include a host using one or more forms of reverse proxy services to proxy traffic before passing it to a gateway router. The database firewall 848 may inspect the contents of database traffic and block certain content or database requests. The database firewall 848 may work on the SQL application level atop the TCP/IP stack, managing applications’ connection to the database or SQL management interfaces as well as intercepting and enforcing packets traveling to or from a database network or application interface.

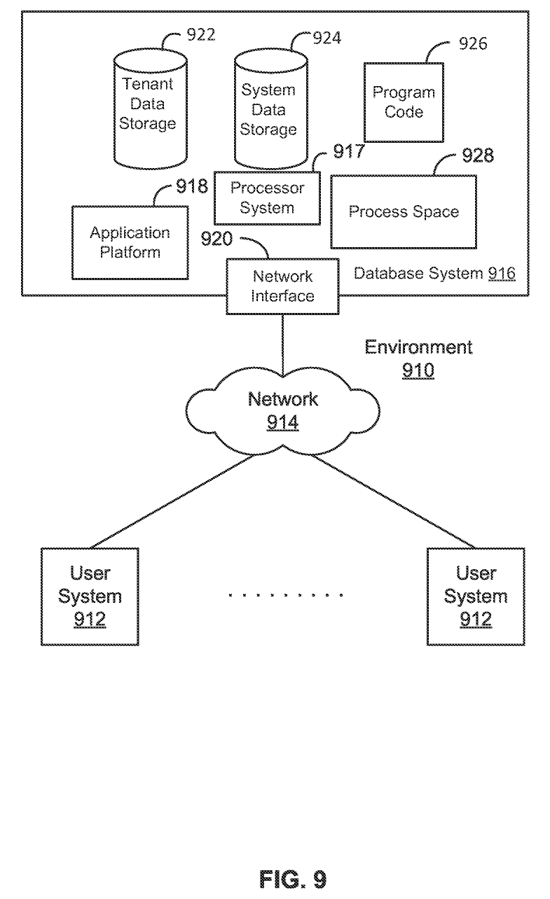

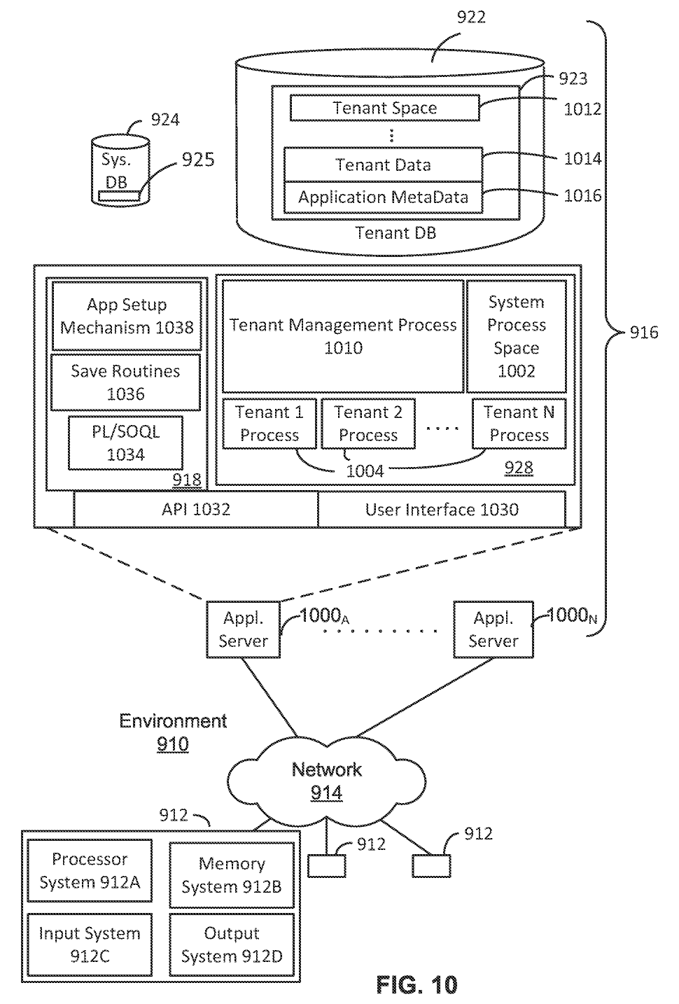

In some implementations, communication with the database storage system 856 may be conducted via the database switch 852. The multi-tenant database system 856 may include more than one hardware and/or software components for handling database queries. Accordingly, the database switch 852 may direct database queries transmitted by other components of the on-demand service environment (e.g., the pods 840 and 844) to the correct components within the database storage system 856. In some implementations, the database storage system 856 is an on-demand database system shared by many different organizations. The on-demand database system may employ a multi-tenant approach, a virtualized approach, or any other type of database approach. An on-demand database system is discussed in greater detail with reference to FIGS. 9 and 10.

FIG. 8B shows a system diagram illustrating the architecture of the pod 844, in accordance with one implementation. The pod 844 may be used to render services to a user of the on-demand service environment 800. In some implementations, each pod may include a variety of servers and/or other systems. The pod 844 includes one or more content batch servers 864, content search servers 868, query servers 882, Fileforce servers 886, access control system (ACS) servers 880, batch servers 884, and app servers 888. Also, the pod 844 includes database instances 890, quick file systems (QFS) 892, and indexers 894. In one or more implementations, some or all communication between the servers in the pod 844 may be transmitted via the switch 836.

In some implementations, the application servers 888 may include a hardware and/or software framework dedicated to the execution of procedures (e.g., programs, routines, scripts) for supporting the construction of applications provided by the on-demand service environment 800 via the pod 844. Some such procedures may include operations for providing the services described herein. The content batch servers 864 may handle requests internal to the pod. These requests may be long-running and/or not tied to a particular customer. For example, the content batch servers 864 may handle requests related to log mining, cleanup work, and maintenance tasks.

The content search servers 868 may provide query and indexer functions. For example, the functions provided by the content search servers 868 may allow users to search through content stored in the on-demand service environment. The Fileforce servers 886 may manage requests for information stored in the Fileforce storage 898. The Fileforce storage 898 may store information such as documents, images, and basic large objects (BLOBs). By managing requests for information using the Fileforce servers 886, the image footprint on the database may be reduced.

The query servers 882 may be used to retrieve information from one or more file systems. For example, the query servers 882 may receive requests for information from the app servers 888 and then transmit information queries to network file systems (NFS) 896 located outside the pod. The pod 844 may share a database instance 890 configured as a multi-tenant environment in which different organizations share access to the same database. Additionally, services rendered by the pod 844 may require various hardware and/or software resources. In some implementations, the ACS servers 880 may control access to data, hardware resources, or software resources.

In some implementations, the batch servers 884 may process batch jobs, which are used to run tasks at specified times. Thus, the batch servers 884 may transmit instructions to other servers, such as the app servers 888, to trigger the batch jobs. For some implementations, the QFS 892 may be an open source file system available from Sun Microsystems® of Santa Clara, California. The QFS may serve as a rapid-access file system for storing and accessing information available within the pod 844. The QFS 892 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 868 and/or indexers 894 to identify, retrieve, move, and/or update data stored in the NFS 896 and/or other storage systems.

In some implementations, one or more query servers 882 may communicate with the NFS 896 to retrieve and/or update information stored outside of the pod 844. The NFS 896 may allow servers located in the pod 844 to access information to access files over a network in a manner similar to how local storage is accessed. In some implementations, queries from the query servers 882 may be transmitted to the NFS 896 via the load balancer 828, which may distribute resource requests over various resources available in the on-demand service environment. The NFS 896 may also communicate with the QFS 892 to update the information stored on the NFS 896 and/or to provide information to the QFS 892 for use by servers located within the pod 844.

In some implementations, the pod may include one or more database instances 890. The database instance 890 may transmit information to the QFS 892. When information is transmitted to the QFS, it may be available for use by servers within the pod 844 without requiring an additional database call. In some implementations, database information may be transmitted to the indexer 894. Indexer 894 may provide an index of information available in the database 890 and/or QFS 892. The index information may be provided to Fileforce servers 886 and/or the QFS 892.

FIG. 9 shows a block diagram of an environment 910 wherein an on-demand database service might be used, in accordance with some implementations. Environment 910 includes an on-demand database service 916. User system 912 may be any machine or system that is used by a user to access a database user system. For example, any of user systems 912 can be a handheld computing system, a mobile phone, a laptop computer, a workstation, and/or a network of computing systems. As illustrated in FIGS. 9 and 10, user systems 912 might interact via a network 914 with the on-demand database service 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDBMS) or the equivalent may execute storage and retrieval of information against the database object(s). Application platform 918 may be a framework that allows the applications of system 916 to run, such as the hardware and/or software, e.g., the operating system. In an implementation, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

The users of user systems 912 may differ in their respective capacities, and the capacity of a particular user system 912 might be entirely determined by permissions (permission levels) for the current user. For example, where a call center agent is using a particular user system 912 to interact with system 916, the user system 912 has the capacities allotted to that call center agent. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user’s security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS’ data; however, other alternative configurations may be used instead.

In some implementations, system 916, shown in FIG. 9, implements a web-based customer relationship management (CRM) system. For example, in some implementations, system 916 includes application servers configured to implement and execute CRM software applications as well as provide related data, code, forms, webpages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant’s data, unless such data is expressly shared. In certain implementations, system 916 implements applications other than, or in addition to, a CRM application. For example, system 916 may provide tenant access to multiple hosted (standard and custom) applications. User (or third party developer) applications, which may or may not include CRM, may be supported by the application platform 918, which manages creation, storage of the applications into one or more database objects and executing of the applications in a virtual machine in the process space of the system 916.

Each user system 912 could include a desktop personal computer, workstation, laptop, PDA, cell phone, or any wireless access protocol (WAP) enabled device or any other computing system capable of interfacing directly or indirectly to the Internet or other network connection. User system 912 typically runs an HTTP client, e.g., a browsing program, such as Microsoft’s Internet Explorer® browser, Mozilla’s Firefox® browser, Opera’s browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914.

Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some implementations, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

A computer program product implementation includes a machine-readable storage medium (media) having instructions stored thereon/in which can be used to program a computer to perform any of the processes of the implementations described herein. Computer code for operating and configuring system 916 to intercommunicate and to process webpages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to some implementations, each system 916 is configured to provide webpages, forms, applications, data and media content to user (client) systems 912 to support the access by user systems 912 as tenants of system 916. As such, system 916 provides security mechanisms to keep each tenant’s data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also shows a block diagram of environment 910 further illustrating system 916 and various interconnections, in accordance with some implementations. FIG. 10 shows that user system 912 may include processor system 912A, memory system 912B, input system 912C, and output system 912D. FIG. 10 shows network 914 and system 916. FIG. 10 also shows that system 916 may include tenant data storage 922, tenant data 923, system data storage 924, system data 925, User Interface (UI) 1030, Application Program Interface (API) 1032, PL/SOQL 1034, save routines 1036, application setup mechanism 1038, applications servers 1000A-1000N, system process space 1002, tenant process spaces 1004, tenant management process space 1010, tenant storage area 1012, user storage 1014, and application metadata 1016. In other implementations, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of processors. Memory system 912B may be any combination of one or more memory devices, short term, and/or long term memory. Input system 912C may be any combination of input devices, such as keyboards, mice, trackballs, scanners, cameras, and/or interfaces to networks. Output system 912D may be any combination of output devices, such as monitors, printers, and/or interfaces to networks. As shown by FIG. 10, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to tenant data storage 922 and the tenant data 923 therein, and system data storage 924 and the system data 925 therein to serve requests of user systems 912. The tenant data 923 might be divided into individual tenant storage areas 1012, which can be either a physical arrangement and/or a logical arrangement of data. Within each tenant storage area 1012, user storage 1014 and application metadata 1016 might be similarly allocated for each user. For example, a copy of a user’s most recently used (MRU) items might be stored to user storage 1014. Similarly, a copy of MRU items for an entire organization that is a tenant might be stored to tenant storage area 1012. A UI 1030 provides a user interface and an API 1032 provides an application programmer interface to system 916 resident processes to users and/or developers at user systems 912. The tenant data and the system data may be stored in various databases, such as Oracle™ databases.

Application platform 918 includes an application setup mechanism 1038 that supports application developers’ creation and management of applications, which may be saved as metadata into tenant data storage 922 by save routines 1036 for execution by subscribers as tenant process spaces 1004 managed by tenant management process 1010 for example. Invocations to such applications may be coded using PL/SOQL 1034 that provides a programming language style interface extension to API 1032. A detailed description of some PL/SOQL language implementations is discussed in commonly assigned U.S. Patent No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed September 21, 2007, which is hereby incorporated by reference in its entirety and for all purposes. Invocations to applications may be detected by system processes, which manage retrieving application metadata 1016 for the subscriber making the invocation and executing the metadata as an application in a virtual machine.

Each application server 1000 may be communicably coupled to database systems, e.g., having access to system data 925 and tenant data 923, via a different network connection. For example, one application server 1000 might be coupled via the network 914 (e.g., the Internet), another application server 1000 might be coupled via a direct network link, and another application server 1000 might be coupled by yet a different network connection. Transfer Control Protocol and Internet Protocol (TCP/IP) are typical protocols for communicating between application servers 1000 and the database system. However, other transport protocols may be used to optimize the system depending on the network interconnect used.

In certain implementations, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In some implementations, therefore, an interface system implementing a load balancing function (e.g., an F5 Big-IP load balancer) is communicably coupled between the application servers 1000 and the user systems 912 to distribute requests to the application servers 1000. In some implementations, the load balancer uses a least connections algorithm to route user requests to the application servers 1000. Other examples of load balancing algorithms, such as round robin and observed response time, also can be used. For example, in certain implementations, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each call center agent uses system 916 to manage their sales process. Thus, a user might maintain contact data, leads data, customer follow-up data, performance data, goals and progress data, etc., all applicable to that user’s personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user’s data might be separate from other users’ data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain implementations, user systems 912 (which may be client machines/systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Patent No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. In some implementations, multiple “tables” for a single customer may actually be stored in one large table and/or in the same table as the data of other customers.

In this description, the "application" refers to computational logic for providing the specified functionality. An application can be implemented in hardware, firmware, and/or software. Where the applications described herein are implemented as software, Where the applications described herein are implemented as software, the application can be implemented as a standalone program, but can also be implemented through other means, for example as part of a larger program, but can also be implemented through other means, for example as part of a larger program, as any number of separate programs, or as one or more statically or dynamically linked libraries. It will be understood that the named applications described herein represent one embodiment, and other embodiments may include other applications. In addition, other embodiments may lack applications described herein and/or distribute the described functionality among the applications in a different manner. Additionally, the functionalities attributed to more than one application can be incorporated into a single application. In an embodiment where the applications as implemented by software, they are stored on a computer readable persistent storage device (e.g., hard disk), loaded into the memory, and executed by one or more processors. Alternatively, hardware or software applications may be stored elsewhere within a computing system.

As referenced herein, a computer or computing system includes hardware elements used for the operations described here, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to an implementation in which a service cloud console is implemented in a system having an application server providing a front end for an on-demand database service capable of supporting multiple tenants, the one or more implementations and techniques are not limited to multi-tenant databases nor deployment on application servers. Implementations may be practiced using other database architectures, i.e., ORACLE®, DB2® by IBM and the like without departing from the scope of the implementations claimed.

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein but should be defined only in accordance with the following and later-submitted claims and their equivalents.

What is claimed is:

1. A computer-implemented method comprising:
obtaining, by a computing system, internal telemetry data corresponding to a plurality of levels of a cloud infrastructure;
predicting, by the computing system, at least one outage to at least one of the plurality of levels of the cloud infrastructure;
determining, by the computing system, a threshold likelihood of at least one outage to the cloud infrastructure based at least in part on the at least one predicted outage; and
in response to determining the threshold likelihood of the at least one outage, causing, by the computing system, initiation of an automated disaster recovery process to failover the at least one of the plurality of levels of the cloud infrastructure.

2. The computer-implemented method of claim 1, wherein the plurality of levels of the cloud infrastructure include at least a region level, an availability zone level, a cell level, and a tenant level.

3. The computer-implemented method of claim 1, wherein the automated disaster recovery process causes the at least one of the plurality of levels of the cloud infrastructure to failover to a different region, availability zone, or cell.

4. The computer-implemented method of claim 1, wherein the at least one outage to the at least one of the plurality of levels of the cloud infrastructure is predicted by an artificial intelligence (AI) anomaly detection model that evaluates the internal telemetry data based at least in part on historical outage data corresponding to the cloud infrastructure.

5. The computer-implemented method of claim 4, wherein the AI anomaly detection model is trained to output respective likelihoods of outages at a region level, an availability zone level, a cell level, and a tenant level of the cloud infrastructure based at least in part upon the evaluation.

6. The computer-implemented method of claim 4, wherein the AI anomaly detection model corresponds to an auto-encoder architecture that includes an encoder trained to compress telemetry data in latent space, a decoder to reconstruct telemetry data, and a clustering layer to group similar patterns of telemetry data.

7. The computer-implemented method of claim 1, further comprising:
determining, by the computing system, respective confidence scores for one or more real-world incidents that affect one or more of the plurality of levels of the cloud infrastructure based at least in part on external telemetry data; and
determining, by the computing system, the threshold likelihood of the at least one outage to the cloud infrastructure based at least in part on the at least one predicted outage and the respective confidence scores.

8. The computer-implemented method of claim 7, wherein the external telemetry data includes at least one of a news feed data, weather data, disaster alert data, or social media data.

9. The computer-implemented method of claim 7, wherein a confidence score for a real-world incident is based on a credibility of the external telemetry data reporting the real-world incident, a severity associated with the real-world incident, and a geographical proximity between the real-world incident and the cloud infrastructure.

10. The computer-implemented method of claim 1, wherein, upon completing the automated disaster recovery process, network traffic to the at least one of the plurality of levels of the cloud infrastructure is redirected to another region, availability zone, or cell.

11. A computer system comprising:
one or more processors; and
memory storing instructions that, when executed, cause the one or more processors to perform:
obtaining internal telemetry data corresponding to a plurality of levels of a cloud infrastructure;
predicting at least one outage to at least one of the plurality of levels of the cloud infrastructure;
determining a threshold likelihood of at least one outage to the cloud infrastructure based at least in part on the at least one predicted outage; and
in response to determining the threshold likelihood of the at least one outage, causing initiation of an automated disaster recovery process to failover the at least one of the plurality of levels of the cloud infrastructure.

12. The computer system of claim 11, wherein the plurality of levels of the cloud infrastructure include at least a region level, an availability zone level, a cell level, and a tenant level.

13. The computer system of claim 11, wherein the automated disaster recovery process causes the at least one of the plurality of levels of the cloud infrastructure to failover to a different region, availability zone, or cell.

14. The computer system of claim 11, wherein the at least one outage to the at least one of the plurality of levels of the cloud infrastructure is predicted by an artificial intelligence (AI) anomaly detection model that evaluates the internal telemetry data based at least in part on historical outage data corresponding to the cloud infrastructure.

15. The computer system of claim 14, wherein the AI anomaly detection model is trained to output respective likelihoods of outages at a region level, an availability zone level, a cell level, and a tenant level of the cloud infrastructure based at least in part upon the evaluation.

16. A non-transitory computer-readable medium storing program code, the program code including instructions that are executable by one or more processors of a computer system to perform:
obtaining internal telemetry data corresponding to a plurality of levels of a cloud infrastructure;
predicting at least one outage to at least one of the plurality of levels of the cloud infrastructure;
determining a threshold likelihood of at least one outage to the cloud infrastructure based at least in part on the at least one predicted outage; and
in response to determining the threshold likelihood of the at least one outage, causing initiation of an automated disaster recovery process to failover the at least one of the plurality of levels of the cloud infrastructure.

17. The non-transitory computer-readable medium of claim 16, wherein the plurality of levels of the cloud infrastructure include at least a region level, an availability zone level, a cell level, and a tenant level.

18. The non-transitory computer-readable medium of claim 16, wherein the automated disaster recovery process causes the at least one of the plurality of levels of the cloud infrastructure to failover to a different region, availability zone, or cell.

19. The non-transitory computer-readable medium of claim 16, wherein the at least one outage to the at least one of the plurality of levels of the cloud infrastructure is predicted by an artificial intelligence (AI) anomaly detection model that evaluates the internal telemetry data based at least in part on historical outage data corresponding to the cloud infrastructure.

20. The non-transitory computer-readable medium of claim 19, wherein the AI anomaly detection model is trained to output respective likelihoods of outages at a region level, an availability zone level, a cell level, and a tenant level of the cloud infrastructure based at least in part upon the evaluation.
